(19) United States
(12) Patent Application Publication
(10) Pub. No.: US 2025/0385590 A1
(43) Pub. Date: Dec. 18, 2025

(54) POWER SUPPLY CONTROL DEVICE

(71) Applicant: ROHM Co., Ltd., Kyoto (JP)

(72) Inventor: Kenichi Okajima, Kyoto (JP)

(73) Assignee: ROHM Co., Ltd., Kyoto (JP)

(21) Appl. No.: 19/093,292

(22) Filed: Mar. 28, 2025

(30) Foreign Application Priority Data
Jun. 14, 2024 (JP) 2024-096558

(51) Int. Cl. H02M 1/00; H02M 3/158

(52) U.S. Cl. CPC H02M 1/0003; H02M 3/158

(57) ABSTRACT

In a power supply device, the state of an output stage circuit is controlled based on a feedback voltage (Vfb) corresponding to an output voltage and a reference voltage (Vref) generated by a first voltage generation circuit (11), thereby stabilizing the output voltage at a target voltage. An abnormality of the output voltage is monitored based on the feedback voltage and an output monitoring voltage (V_H, V_L) generated by a second voltage generation circuit (12). Abnormalities of the first and second voltage generation circuits are detected distinctively based on a first determination voltage (V1a, V1b) generated by the first voltage generation circuit, a second determination voltage (V2a, V2b) generated by the second voltage generation circuit, and a third determination voltage (V3a, V3b, V3c, V3d) generated by a third voltage generation circuit.

### CROSS-REFERENCE TO RELATED APPLICATION

This application claims the priority benefit of Japanese application serial no. 2024-096558, filed on Jun. 14, 2024. The entirety of the above-mentioned patent application is hereby incorporated by reference herein and made a part of this specification.

### TECHNICAL FIELD

The disclosure relates to a power supply control device.

### BACKGROUND

In a power supply device that generates an output voltage from an input voltage, stabilization of the output voltage is often achieved by feedback control based on the error between a feedback voltage corresponding to the output voltage and a reference voltage (see, for example, Patent Document 1 (International Publication No. 2021/054027) below). A power supply control device is used as a device for controlling the operation of the power supply device, and the reference voltage is generated within the power supply control device.

For this type of power supply control device, a function is required to detect various abnormalities that may occur within the power supply control device.

### SUMMARY

A power supply control device according to one aspect of the disclosure is a power supply control device that includes an output stage circuit provided between an input terminal to which an input voltage is applied and an output terminal to which an output voltage is applied, and constitutes a power supply device configured to generate the output voltage from the input voltage. The power supply control device includes: a first voltage generation circuit; a control circuit configured to stabilize the output voltage at a target voltage by controlling a state of the output stage circuit based on a feedback voltage corresponding to the output voltage and a reference voltage generated by the first voltage generation circuit; a second voltage generation circuit; an output abnormality monitoring circuit configured to monitor an abnormality of the output voltage based on the feedback voltage and an output monitoring voltage generated by the second voltage generation circuit; a third voltage generation circuit; and a state detection circuit configured to detect abnormalities of the first voltage generation circuit and the second voltage generation circuit distinctively based on a first determination voltage generated by the first voltage generation circuit, a second determination voltage generated by the second voltage generation circuit, and a third determination voltage generated by the third voltage generation circuit.

### BRIEF DESCRIPTION OF THE DRAWINGS

FIG. 1 is a schematic overall configuration diagram of the system according to an embodiment of the disclosure.

FIG. 2 is an external perspective view of the power supply control device according to an embodiment of the disclosure.

FIG. 3 is a configuration diagram of the power supply device according to an embodiment of the disclosure.

FIG. 4 is a configuration diagram of the reference power supply device according to the first reference example.

FIG. 5 is a configuration diagram of the reference power supply device according to the second reference example.

FIG. 6 is an internal configuration diagram of the state detection circuit according to an embodiment of the disclosure.

FIG. 7 is an explanatory diagram of the detection method and detection content of the state detection circuit according to the first implementation example belonging to an embodiment of the disclosure.

FIG. 8 is an explanatory diagram of the abnormality detection method of the voltage generation circuit according to the first implementation example belonging to an embodiment of the disclosure.

FIG. 9 is an explanatory diagram of the abnormality detection method of the voltage generation circuit according to the first implementation example belonging to an embodiment of the disclosure.

FIG. 10 is an explanatory diagram of the abnormality detection method of the voltage generation circuit according to the first implementation example belonging to an embodiment of the disclosure.

FIG. 11 is an explanatory diagram of the abnormality detection method of the voltage generation circuit according to the first implementation example belonging to an embodiment of the disclosure.

FIG. 12 is a diagram showing the response method in a case where an abnormality occurs in the voltage generation circuit that generates the reference voltage, according to the second implementation example belonging to an embodiment of the disclosure.

FIG. 13 is a diagram showing a modified configuration of the output stage circuit according to the fourth implementation example belonging to an embodiment of the disclosure.

FIG. 14 is a diagram showing a modified configuration of the output stage circuit according to the fourth implementation example belonging to an embodiment of the disclosure.

### DETAILED DESCRIPTION

Hereinafter, examples of embodiments of the disclosure will be specifically described with reference to the figures. In each referenced figure, the same parts are given the same reference numerals, and repeated descriptions related to the same parts are omitted in principle. It should be noted that in this specification, for simplification of description, the names of information, signals, physical quantities, functional parts, circuits, elements, or components corresponding to symbols or reference numerals may be omitted or abbreviated by indicating the symbols or reference numerals referring to the information, signals, physical quantities, functional parts, circuits, elements, or components.

First, an explanation is provided for several terms used in the description of embodiments of the disclosure. Ground refers to a reference conductor having a potential of OV (zero volts) that serves as a reference, or refers to a potential of OV itself. The reference conductor may be formed using a conductor such as metal. The potential of OV may also be called a ground potential. In embodiments of the disclosure, a voltage shown without particularly setting a reference represents a potential as seen from the ground. Level refers to the level (height) of a potential, and for any signal or voltage of interest, high level has a higher potential than low level.

For any transistor configured as a FET (field effect transistor) exemplified by a MOSFET, on state refers to a state in which there is conduction between drain and source of the transistor, and off state refers to a state in which there is no conduction between drain and source of the transistor (blocked state). The same applies to transistors not classified as a FET. Unless otherwise stated, a MOSFET is understood to be an enhancement type MOSFET. MOSFET is an abbreviation for “metal-oxide-semiconductor field-effect transistor.” Also, unless otherwise stated, in any MOSFET, the back gate may be considered to be shorted to the source.

Hereinafter, for any transistor, the on state and off state may also be simply expressed as on and off. In addition, for any transistor, the period during which the transistor is set to the on state is called the on period, and the period during which the transistor is set to the off state is called the off period. Connection between multiple parts forming a circuit, such as any circuit element, wiring, and node, may be understood to refer to electrical connection, unless otherwise stated.

In a case where any two voltages to be compared are voltage v1 and voltage v2, “v1>v2” indicates that voltage v1 is higher than voltage v2, “v1<v2” indicates that voltage v1 is lower than voltage v2, and “v1=v2” indicates that the value of voltage v1 is the same as the value of voltage v2. The same applies to other formulas including physical quantities other than voltage.

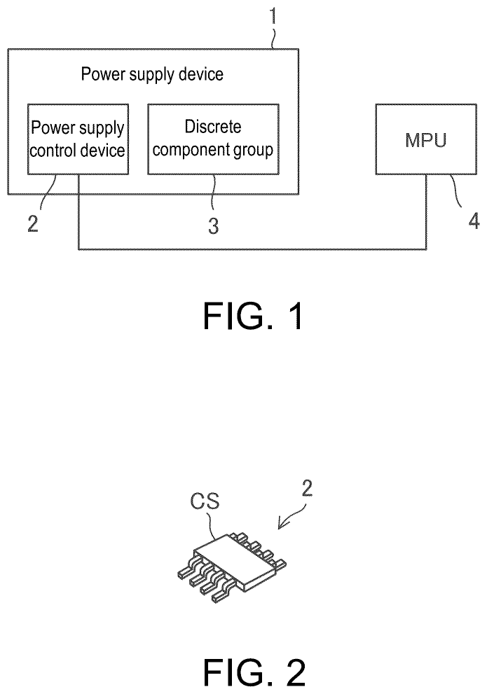

FIG. 1 is an overall configuration diagram of a system according to an embodiment of the disclosure. The system in FIG. 1 includes a power supply device 1 and an MPU (Micro Processing Unit) 4. The power supply device 1 includes a power supply control device 2 that controls the operation of the power supply device 1, and a discrete component group 3 composed of multiple discrete components externally connected to the power supply control device 2. The MPU 4 is an example of an external device provided outside the power supply control device 2. The MPU 4 is connected to the power supply control device 2. The power supply control device 2 and the MPU 4 may be connected in a manner that enables bidirectional communication with each other.

FIG. 2 shows an external perspective view of the power supply control device 2. The power supply control device 2 is an electronic component including a semiconductor chip having a semiconductor integrated circuit formed on a semiconductor substrate, a housing CS (package) accommodating the semiconductor chip, and multiple external terminals exposed from the housing CS to the outside of the power supply control device 2. The power supply control device 2 is formed by encapsulating the semiconductor chip in the housing CS made of resin. It should be noted that the number of external terminals of the power supply control device 2 and the type of the housing CS of the power supply control device 2 shown in FIG. 2 are merely exemplary, and these can be designed arbitrarily.

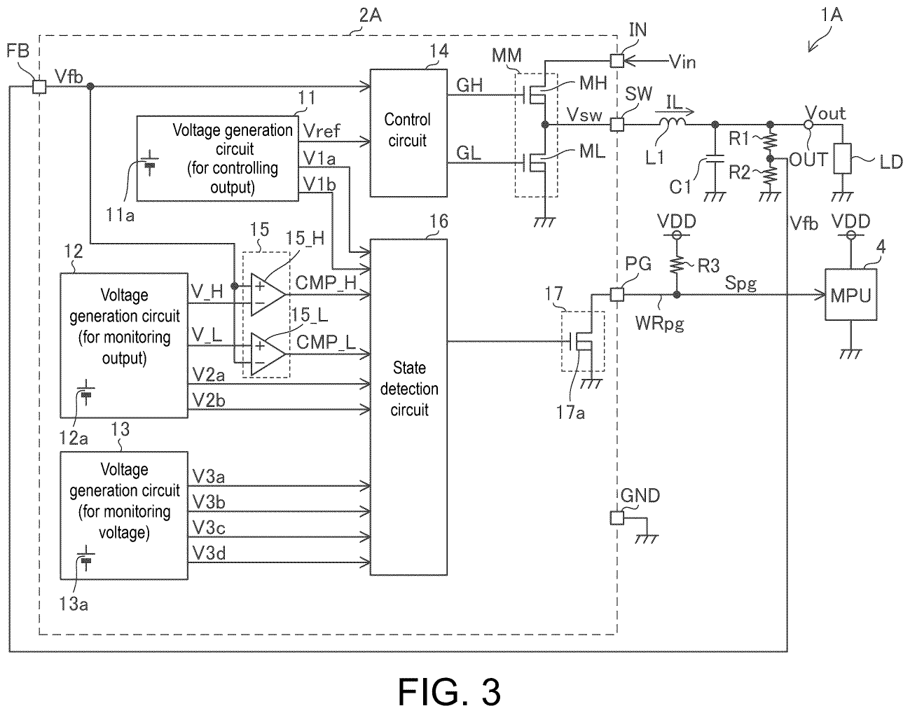

FIG. 3 shows the configuration of a power supply device 1A which is an example of the power supply device 1. The power supply device 1A includes a power supply control device 2A as the power supply control device 2. The discrete component group 3 in the power supply device 1A includes a coil L1, an output capacitor C1, and feedback resistors R1 and R2. A pull-up resistor R3 shown in FIG. 3 may be understood as not included in the constituent elements of the power supply device 1A, or may be understood as included in the constituent elements of the power supply device 1A (included in the constituent elements of the discrete component group 3).

The power supply device 1A is configured as a step-down type switching power supply device (DC/DC converter) that generates a desired output voltage Vout from an input voltage Vin supplied from a voltage source (not shown). The output voltage Vout is generated at an output terminal OUT. That is, the output terminal OUT is the application terminal of the output voltage Vout (the terminal to which the output voltage Vout is applied). The output voltage Vout is supplied to a load LD connected to the output terminal OUT. In the power supply device 1A, the input voltage Vin and the output voltage Vout are positive DC voltages, and the output voltage Vout is lower than the input voltage Vin. For example, in a case where the input voltage Vin is 12V, the output voltage Vout can be stabilized at a desired positive voltage value less than 12V (for example, 3.3V or 5V) by adjusting the resistance values of the feedback resistors R1 and R2.

In FIG. 3, only an input terminal IN, a switch terminal SW, a feedback terminal FB, a ground terminal GND, and a power good terminal PG are shown as some of multiple external terminals provided in the power supply control device 2A, but other external terminals (for example, enable terminal and boot terminal) may also be provided in the power supply control device 2A. The external configuration of the power supply control device 2A will be described.

The input voltage Vin is supplied to the input terminal IN from a DC voltage source (not shown) provided outside the power supply control device 2A. The coil L1 is interposed in series between the switch terminal SW and the output terminal OUT. That is, the first terminal of the coil L1 is connected to the switch terminal SW, and the second terminal of the coil L1 is connected to the output terminal OUT. Also, the output terminal OUT is connected to the ground through the output capacitor C1. That is, the first terminal of the output capacitor C1 is connected to the output terminal OUT, and the second terminal of the output capacitor Cl is connected to the ground. Furthermore, the output terminal OUT is connected to the first terminal of the feedback resistor R1, the second terminal of the feedback resistor R1 is connected to the first terminal of the feedback resistor R2, and the second terminal of the feedback resistor R2 is connected to the ground. A feedback voltage Vfb is generated at the connection node between the feedback resistors R1 and R2. The connection node between the feedback resistors R1 and R2 is connected to the feedback terminal FB, thereby inputting the feedback voltage Vfb to the feedback terminal FB. The ground terminal GND is connected to the ground. It should be noted that the current flowing through the coil L1 is referred to as a coil current IL.

A wiring WRpg is a wiring provided externally. The first terminal of the wiring WRpg is connected to the power good terminal PG, and the second terminal of the wiring WRpg is connected to the input terminal of the MPU 4. The signal on the wiring WRpg is referred to as a signal Spg. The wiring WRpg is a wiring for transmitting the signal Spg to the MPU 4. The first terminal of the pull-up resistor R3 is connected to the application terminal of a power supply voltage VDD (the terminal to which the power supply voltage VDD is applied), and the second terminal of the pull-up resistor R3 is connected to the wiring WRpg. The power supply voltage VDD is a positive DC voltage. The MPU 4 is connected to the application terminal of the power supply voltage VDD and the ground, and operates based on the power supply voltage VDD.

The internal configuration of the power supply control device 2A will be described. The power supply control device 2A includes an output stage circuit MM and a control circuit 14 for controlling the output stage circuit MM, as well as voltage generation circuits 11, 12, and 13, an output abnormality monitoring circuit 15, a state detection circuit 16, and a signal output circuit 17. The signal output circuit 17 includes a transistor 17a which is an N-channel type MOSFET.

The output stage circuit MM includes transistors MH and ML configured as N-channel type MOSFETs. The transistors MH and ML are a pair of switching elements connected in series between the input terminal IN and the ground terminal GND (in other words, the ground), and these are switching-driven so that the input voltage Vin is switched to generate a rectangular wave form switch voltage Vsw at the switch terminal SW. The transistor MH is provided on the higher potential side than the transistor ML. Specifically, the drain of the transistor MH is connected to the input terminal IN, which is the application terminal of the input voltage Vin, and receives the supply of the input voltage Vin. The source of the transistor MH and the drain of the transistor ML are commonly connected to the switch terminal SW. The source of the transistor ML is connected to the ground. However, in some cases, a resistor for current detection may be inserted between the source of the transistor ML and the ground.

The transistor MH functions as an output element (output transistor), and the transistor ML functions as a rectification element (synchronous rectification transistor). The output stage circuit MM is switching-controlled by the control circuit 14. In the switching control of the output stage circuit MM, the transistors MH and ML are alternately turned on and off. The coil L1 and the output capacitor C1 constitute a rectification smoothing circuit that rectifies and smooths the rectangular wave form switch voltage Vsw appearing at the switch terminal SW to generate the output voltage Vout. The feedback resistors R1 and R2 constitute a feedback voltage generation circuit that generates the feedback voltage Vfb corresponding to the output voltage Vout by dividing the output voltage Vout. The feedback voltage Vfb is proportional to the output voltage Vout, and the feedback voltage Vfb also rises and falls with the rise and fall of the output voltage Vout. It should be noted that a modification may be made to use the output voltage Vout itself as the feedback voltage Vfb. In any case, the feedback voltage Vfb is a voltage corresponding to the output voltage Vout.

Gate signals GH and GL are respectively supplied as drive signals to the gates of the transistors MH and ML, and the transistors MH and ML are turned on and off in response to the gate signals GH and GL. In a case where the gate signal GH is at high level, the transistor MH is in the on state, and in a case where the gate signal GH is at low level, the transistor MH is in the off state. Similarly, in a case where the gate signal GL is at high level, the transistor ML is in the on state, and in a case where the gate signal GL is at low level, the transistor ML is in the off state. Basically, the transistors MH and ML are alternately turned on and off, but there are cases where both the transistors MH and ML are maintained in the off state. The transistors MH and ML are not simultaneously set to the on state. It should be noted that the output stage circuit MM may be provided outside the power supply control device 2A. In this case, the output stage circuit MM provided outside the power supply control device 2A is connected to the power supply control device 2A.

In a situation where the coil current IL flows from the switch terminal SW toward the output terminal OUT, the coil current IL flows through the channel (between drain and source) of the transistor MH during the on period of the transistor MH, and the coil current IL flows through the channel of the transistor ML or the parasitic diode of the transistor ML during the off period of the transistor MH.

The control circuit 14 is connected to the feedback terminal FB and receives the feedback voltage Vfb at the feedback terminal FB. The control circuit 14 performs switching control of the output stage circuit MM based on the feedback voltage Vfb and a reference voltage Vref supplied from the voltage generation circuit 11. In the switching control of the output stage circuit MM, the control circuit 14 controls the on/off state of each of the transistors MH and ML through level control of the gate signals GH and GL so that the error between the feedback voltage Vfb and the reference voltage Vref approaches zero (ideally matches zero), thereby stabilizing the output voltage Vout at a predetermined target voltage Vtg. In a case where the error between the feedback voltage Vfb and the reference voltage Vref is zero, the output voltage Vout matches the target voltage Vtg (that is, the value of the output voltage Vout matches the value of the target voltage Vtg).

The voltage generation circuit 11 is a voltage generation circuit for controlling output. The voltage generation circuit 11 generates the reference voltage Vref as a voltage for controlling the output voltage Vout. The voltage generation circuit 11 generates the reference voltage Vref so that the reference voltage Vref has a predetermined positive DC voltage value.

In addition, the voltage generation circuit 11 generates and outputs voltages V1a and V1b to the state detection circuit 16. The voltages V1a and V1b are examples of constituent elements of a first determination voltage. The reference voltage Vref and the voltages V1a and V1b are generated as three voltages proportional to the output voltage of a single DC voltage source 11a provided within the voltage generation circuit 11. For example, the reference voltage Vref and the voltages V1a and V1b are generated by dividing the output voltage of the DC voltage source 11a using ladder resistance. However, the reference voltage Vref, the voltage V1a, or the voltage V1b may be the voltage before the division.

In any case, the reference voltage Vref, the voltage V1a, and the voltage V1b are in a proportional relationship with each other. That is, the first determination voltage (V1a, V1b) is proportional to the reference voltage Vref. Therefore, in a case where the output voltage of the reference voltage source 11a is a voltage V11a, “Vref=k1×V11a,” “V1a=k1a×V11a,” and “V1b=k1b×V11a” are established.

k1, k1a, and k1b are predetermined positive proportionality constants. At least one of the proportionality constants k1, k1a, and k1b may be 1. The proportionality constants k1, k1a, and k1b may differ from each other. Any two or more of the proportionality constants k1, k1a, and k1b may have the same value. “k1=k1a” may be true, and in this case, the reference voltage Vref and the voltage V1a are common voltages. “k1=k1b” may be true, and in this case, the reference voltage Vref and the voltage V1b are common voltages. “k1a=k1b” may be true, and in this case, the voltage V1a and the voltage V1b are common voltages.

The voltage generation circuit 12 is a voltage generation circuit for monitoring output. The voltage generation circuit 12 generates voltages V_H and V_L as output monitoring voltages for monitoring whether the output voltage Vout falls within a predetermined normal voltage range. The voltage generation circuit 12 generates the voltages V_H and V_L so that the voltages V_H and V_L have positive DC voltage values and “V_H>V_L” is established. Therefore, in a case where the voltage generation circuit 12 is operating normally, “V_H>V_L>0” is established.

The voltage generation circuit 12 also generates and outputs voltages V2a and V2b to the state detection circuit 16. The voltages V2a and V2b are examples of constituent elements of a second determination voltage. The voltages V_H, V_L, V2a, and V2b are generated as four voltages proportional to the output voltage of a single DC voltage source 12a provided within the voltage generation circuit 12. For example, the voltages V_H, V_L, V2a, and V2b are generated by dividing the output voltage of the DC voltage source 12a using ladder resistance. However, the voltage V_H, V_L, V2a, or V2b may be the voltage before the division.

In any case, the voltages V_H, V_L, V2a, and V2b are in a proportional relationship with each other, and the second determination voltage (V2a, V2b) is proportional to the output monitoring voltage (V_H, V_L). Therefore, in a case where the output voltage of the reference voltage source 12a is a voltage V12a, “V_H=k2_H×V12a,” “V_L=k2_L×V12a,” “V2a=k2a×V12a,” and “V2b=k2b×V12a” are established. k2_H, k2_L, k2a, and k2b are predetermined positive proportionality constants. At

least one of the proportionality constants k2_H, k2_L, k2a, and k2b may be 1. However, the proportionality constant k2_H is greater than the proportionality constant k2_L. The proportionality constants k2_H, k2_L, k2, and k2b may differ from each other. “k2_H=k2a” may be true, and in this case, the voltage V_H and the voltage V2a are common voltages. Alternatively, “k2_L=k2a” may be true, and in this case, the voltage V_L and the voltage V2a are common voltages. “k2_H=k2b” may be true, and in this case, the voltage V_H and the voltage V2b are common voltages. Alternatively, “k2_L=k2b” may be true, and in this case, the voltage V_L and the voltage V2b are common voltages. “k2a=k2b” may be true, and in this case, the voltage V2a and the voltage V2b are common voltages.

The voltage generation circuit 13 is a voltage generation circuit for monitoring voltage (a circuit for monitoring the generated voltages of the voltage generation circuits 11 and 12). The voltage generation circuit 13 generates voltages V3a, V3b, V3c, and V3d, which are used for determining whether the generated voltages of the voltage generation circuits 11 and 12 are normal or abnormal, and outputs these voltages to the state detection circuit 16. The voltages V3a, V3b, V3c, and V3d are examples of constituent elements of a third determination voltage. The voltages V3a, V3b, V3c, and V3d are generated as four voltages proportional to the output voltage of a single DC voltage source 13a provided within the voltage generation circuit 13. For example, the voltages V3a, V3b, V3c, and V3d are generated by dividing the output voltage of the DC voltage source 13a using ladder resistance. However, the voltage V3a, V3b, V3c, or V3d may be the voltage before the division.

In any case, the voltages V3a, V3b, V3c, and V3d are in a proportional relationship

with each other. Therefore, in a case where the output voltage of the reference voltage source 13a is a voltage V13a, “V3a=k3a×V13a,” “V3b=k3b×V13a,” “V3c=k3c×V13a,” and “V3d=k3d×V13a” are established.

k3a, k3b, k3c, and k3d are predetermined positive proportionality constants. At least one of the proportionality constants k3a, k3b, k3c, and k3d may be 1. The proportionality constants k3a, k3b, k3c, and k3d may differ from each other. Two or more of the proportionality constants k3a, k3b, k3c, and k3d may have the same value. For example, in a case of “k3a=k3b,” the voltage V3a and the voltage V3b are common voltages, and in a case of “k3b=k3c,” the voltage V3b and the voltage V3c are common voltages. The same applies to other combinations of the proportionality constants k3a, k3b, k3c, and k3d.

The feedback voltage Vfb is supplied to the output abnormality monitoring circuit 15 through the feedback terminal FB, and the voltages V_H and V_L are supplied from the voltage generation circuit 12. The output abnormality monitoring circuit 15 includes comparators 15_H and 15_L. Each of the comparators 15_H and 15_L is a two-input comparator. In this embodiment, any two-input comparator has a non-inverting input terminal, an inverting input terminal, and an output terminal, and compares a positive-side comparison voltage, which is the voltage at the non-inverting input terminal, with a negative-side comparison voltage, which is the voltage at the inverting input terminal, and outputs a comparison result signal indicating the comparison result from the output terminal thereof. At this time, the two-input comparator outputs a comparison result signal at high level in a case where the positive-side comparison voltage is higher than the negative-side comparison voltage, outputs a comparison result signal at low level in a case where the negative-side comparison voltage is higher than the positive-side comparison voltage, and outputs a comparison result signal at high level or low level in a case where the positive-side comparison voltage and the negative-side comparison voltage match.

The non-inverting input terminal of the comparator 15_H receives the feedback voltage Vfb, and the inverting input terminal of the comparator 15_H receives the voltage V_H. A comparison result signal CMP_H indicating the high-low relationship between the feedback voltage Vfb and the voltage V_H is output from the output terminal of the comparator 15_H. Therefore, the comparison result signal CMP_H has high level in the period when “Vfb>V_H” is established, and the comparison result signal CMP_H has low level in the period when “Vfb<V_H” is established.

The inverting input terminal of the comparator 15_L receives the feedback voltage Vfb, and the non-inverting input terminal of the comparator 15_L receives the voltage V_L. A comparison result signal CMP_L indicating the high-low relationship between the feedback voltage Vfb and the voltage V_L is output from the output terminal of the comparator 15_L. Therefore, the comparison result signal CMP_L has high level in the period when “Vfb<V_L” is established, and the comparison result signal CMP_L has low level in the period when “Vfb>V_L” is established.

A window comparator is formed by the comparators 15_H and 15_L to determine whether the output voltage Vout falls within a predetermined normal voltage range. In other words, the output abnormality monitoring circuit 15 monitors an abnormality of the output voltage Vout based on the feedback voltage Vfb and the output monitoring voltage (voltages V_H and V_L) generated by the voltage generation circuit 12, and this monitoring corresponds to monitoring whether the output voltage Vout falls within the predetermined normal voltage range. Monitoring whether the output voltage Vout falls within the normal voltage range is realized by monitoring whether the feedback voltage Vfb falls within a voltage range from the voltage V_L (first output monitoring voltage) to the voltage V_H (second output monitoring voltage) which is higher than the voltage V_L. The comparison result signal CMP_H or CMP_L at high level indicates that the output voltage Vout deviates from the normal voltage range. Specifically, the comparison result signal CMP_H at high level indicates that the output voltage Vout exceeds the upper limit of the normal voltage range, and the comparison result signal CMP_L at high level indicates that the output voltage Vout falls below the lower limit of the normal voltage range. In a case where both the comparison result signals CMP_H and CMP_L are at low level, the comparison result signals CMP_H and CMP_L indicate that the output voltage Vout falls within the normal voltage range.

The comparison result signals CMP_H and CMP_L are input to the state detection circuit 16 along with the voltages V1a, V1b, V2a, V2b, V3a, V3b, V3c, and V3d. Hereinafter, the voltage group composed of the voltages V1a, V1b, V2a, V2b, V3a, V3b, V3c, and V3d may be referred to as a determination voltage group for convenience. The state detection circuit 16 controls the transistor 17a to be on or off by controlling the gate voltage of the transistor 17a, which has an open drain configuration, based on the comparison result signals CMP_H and CMP_L. The state detection circuit 16 turns on the transistor 17a in a case where the comparison result signal CMP_H or CMP_L has high level, and turns off the transistor 17a in a case where the comparison result signals CMP_H and CMP_L both have low level. However, the state detection circuit 16 may also control the state of the transistor 17a based not only on the comparison result signals CMP_H and CMP_L but also on the determination voltage group.

The drain of the transistor 17a is connected to the power good terminal PG, and the source of the transistor 17a is connected to the ground. Therefore, in a case where the transistor 17a is off, the signal Spg has high level (level of the power supply voltage VDD), and in a case where the transistor 17a is on, the signal Spg has low level (substantially level of 0V). The signal Spg at low level indicates that the output voltage Vout is abnormal, or that there is a possibility that the output voltage Vout is abnormal. An abnormality of the output voltage Vout refers to a state where the error between the output voltage Vout and the target voltage Vtg is greater than the product of the output voltage Vout and a constant factor (for example, 3%).

In addition, the state detection circuit 16 detects whether each of the voltage generation circuits 11, 12, and 13 is normal or abnormal based on the determination voltage group (details will be described later).

It should be noted that although not particularly shown, an internal power supply circuit that generates an internal power supply voltage based on the input voltage Vin is provided in the power supply control device 2A. Each circuit in the power supply control device 2A operates based on the input voltage Vin or the internal power supply voltage. Although it may not be particularly shown, each circuit of the power supply control device 2A is connected to the ground. Also, while the gate signal GL is a signal referenced to the ground potential, the gate signal GH is a signal referenced to the potential of the switch terminal SW. The gate signal GH at low level has the potential of the switch terminal SW, and the gate signal GH at high level is higher by a predetermined voltage as seen from the potential of the switch terminal SW. The predetermined voltage here is greater than the gate threshold voltage of the transistor MH. A well-known bootstrap circuit (not shown) can be used to generate a step-up power supply for generating the gate signal GH. The transistor MH may be configured with a P-channel type MOSFET, in which case the step-up power supply is not necessary.

Also, as a modification, a diode rectification system may be adopted in the power supply device 1A. In this case, as a rectification element, instead of the transistor ML, a synchronous rectification diode having an anode connected to the ground terminal GND and a cathode connected to the switch terminal SW is provided in the power supply device 1A. In this case, in the switching drive of the output stage circuit MM, only the output element (MH) is turned on and off. In any case, in the switching drive of the output stage circuit MM, the output voltage Vout is generated based on the current (IL) flowing through the coil L1 as the output element (MH) is switched between on and off.

Prior to the detailed description of the state detection circuit 16, reference power supply devices according to reference examples different from the power supply device 1 (1A) of this embodiment will be described.

### First Reference Example

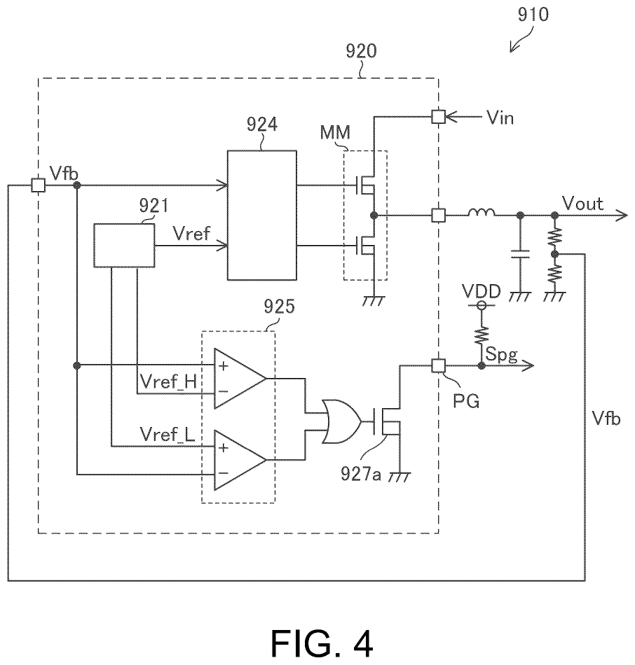

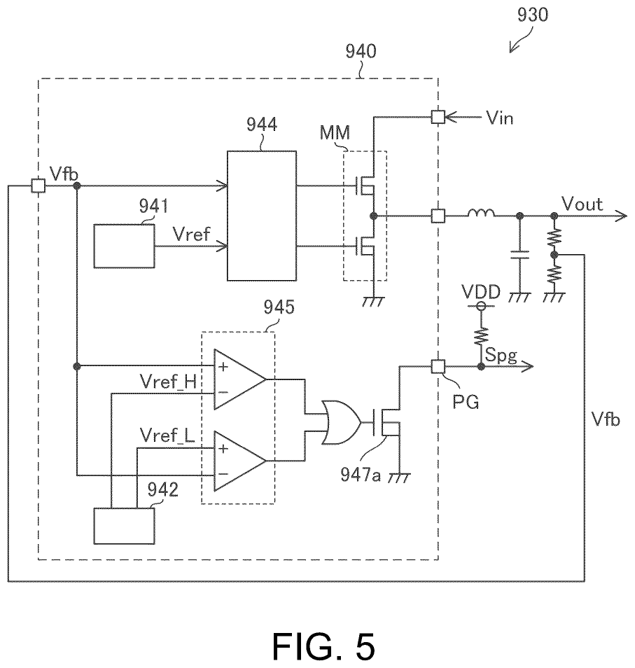

FIG. 4 shows the configuration of a reference power supply device 910 according to the first reference example. The reference power supply device 910 is a step-down type switching power supply device including a power supply control device 920, and generates an output voltage Vout from an input voltage Vin through switching control of an output stage circuit MM. In the power supply control device 920, a control circuit 924 performs switching control of the output stage circuit MM so that the error between a feedback voltage Vfb corresponding to the output voltage Vout and a reference voltage Vref from a voltage generation circuit (reference voltage source) 921 approaches zero. The voltage generation circuit 921 generates, in addition to the reference voltage Vref, two voltages Vref_H and Vref_L that are proportional to the reference voltage Vref. “Vref_H>Vref>Vref_L.” In the reference power supply device 910, an output abnormality monitoring circuit 925 having a window comparator determines whether the output voltage Vout falls within a normal voltage range by comparing the feedback voltage Vfb with each of the voltages Vref_H and Vref_L. In the reference power supply device 910, a transistor 927a with an open drain configuration is used, and in a case of determining that the output voltage Vout falls within the normal voltage range, the signal Spg becomes high level as the transistor 927a is turned off, and in a case of determining that the output voltage Vout deviates from the normal voltage range, the signal Spg becomes low level as the transistor 927a is turned on. In the reference power supply device 910, the signal Spg at high level functions as an output normality signal indicating that the output voltage Vout is normal, and the signal Spg at low level functions as an output abnormality signal indicating that the output voltage Vout is abnormal (the same applies to the reference power supply device 930 in FIG. 5 described later).

In the reference power supply device 910, even if the output voltage Vout becomes abnormal due to an abnormality occurring in the voltage generation circuit 921, the signal Spg may be maintained at high level. That is, in a case where the reference voltage Vref rises from the design voltage due to an abnormality in the DC voltage source within the voltage generation circuit 921, the output voltage Vout also rises from the design voltage and the feedback voltage Vfb also rises, but since the voltages Vref_H and Vref_L also rise in conjunction with the rise of the reference voltage Vref, the signal Spg remains at high level. Conversely, in a case where the reference voltage Vref falls from the design voltage due to an abnormality in the DC voltage source within the voltage generation circuit 921, the output voltage Vout also falls from the design voltage and the feedback voltage Vfb also falls, but since the voltages Vref_H and Vref_L also fall in conjunction with the fall of the reference voltage Vref, the signal Spg remains at high level.

### Second Reference Example

FIG. 5 shows the configuration of a reference power supply device 930 according to the second reference example. The reference power supply device 930 is a step-down type switching power supply device including a power supply control device 940, and similar to the reference power supply device 910 in FIG. 4, generates an output voltage Vout from an input voltage Vin through switching control of an output stage circuit MM. In the power supply control device 940, a control circuit 944 performs switching control of the output stage circuit MM so that the error between a feedback voltage Vfb corresponding to the output voltage Vout and a reference voltage Vref from a voltage generation circuit (reference voltage source) 941 approaches zero. In the power supply control device 940, a voltage generation circuit 942 for monitoring output is provided separately from the voltage generation circuit 941 for controlling output, and the voltage generation circuit 942 generates a voltage V_H and a voltage V_L that is lower than the voltage V_H. In the reference power supply device 930, an output abnormality monitoring circuit 945 having a window comparator determines whether the output voltage Vout falls within a normal voltage range by comparing the feedback voltage Vfb with each of the voltages V_H and V_L. In the reference power supply device 930, a transistor 947a with an open drain configuration is used, and in a case of determining that the output voltage Vout falls within the normal voltage range, the signal Spg becomes high level as the transistor 947a is turned off, and in a case of determining that the output voltage Vout deviates from the normal voltage range, the signal Spg becomes low level as the transistor 947a is turned on.

In the reference power supply device 930, in a case where the reference voltage Vref rises from the design voltage due to an abnormality in the voltage generation circuit 941, the output voltage Vout also rises from the design voltage and the feedback voltage Vfb also rises, resulting in the establishment of “Vfb>V_H,” which turns the transistor 947a on and sets the signal Spg to low level (the signal Spg becomes an output abnormality signal). Conversely, in a case where the reference voltage Vref falls from the design voltage due to an abnormality in the voltage generation circuit 941, the output voltage Vout also falls from the design voltage and the feedback voltage Vfb also falls, resulting in the establishment of “Vfb<V_L,” which turns the transistor 947a on and sets the signal Spg to low level (the signal Spg becomes an output abnormality signal). In other words, by using the voltage generation circuit 942, it is possible to correctly detect an abnormality in the output voltage Vout caused by an abnormality in the voltage generation circuit 941.

On the other hand, in the reference power supply device 930, in a case where the voltages Vref_H and Vref_L rise or fall due to an abnormality in the voltage generation circuit 942, the signal Spg may become low level even though the output voltage Vout is normal. Therefore, in the reference power supply device 930, it is possible to indicate an abnormality through the signal Spg in a case of an abnormality occurring in either of the voltage generation circuits 941 and 942. However, with the reference power supply device 930, it is not possible to determine which of the voltage generation circuits 941 and 942 has the abnormality. If it were possible to determine which of the voltage generation circuits 941 and 942 has the abnormality, it would be beneficial because it would enable responses such as holding flag data according to the determination result, outputting the signal Spg according to the determination result, or notifying an external device of flag data according to the determination result, or even replacing the reference voltage used for switching control from the reference voltage Vref to another voltage in response to an abnormality occurring in the voltage generation circuit 941.

In the following, the first to fourth implementation examples describe the details of the power supply device 1 according to this embodiment (especially the details of the state detection circuit 16), application technologies, or modification technologies, which are configured in consideration of matters related to the reference power supply devices 910 and 930.

### First Implementation Example

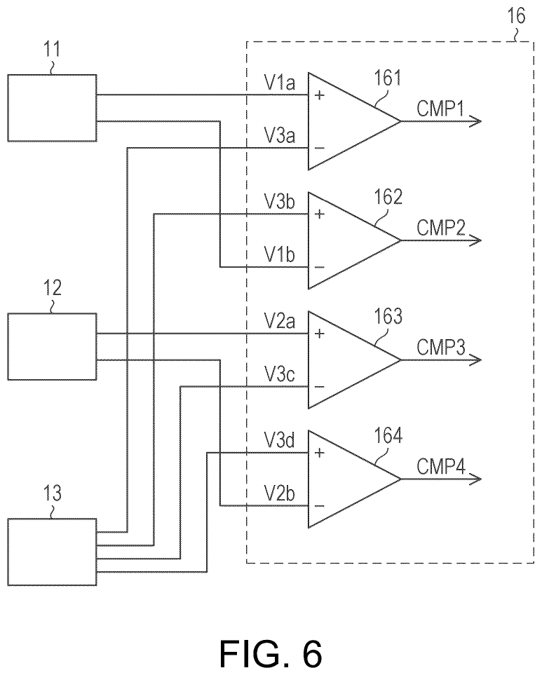

The first implementation example will be described. As shown in FIG. 6, the state detection circuit 16 according to the first implementation example is provided with comparators 161 to 164. The comparators 161 to 164 are each two-input comparators.

The non-inverting input terminal and the inverting input terminal of the comparator 161 respectively receive the voltage V1a and the voltage V3a. The comparator 161 compares the voltages V1a and V3a and outputs a comparison result signal CMP1 from the output terminal thereof indicating the high-low relationship between the voltages V1a and V3a. The comparator 161 outputs the comparison result signal CMP1 at high level in a case where “V1a>V3a” is established, outputs the comparison result signal CMP1 at low level in a case where “V1a<V3a” is established, and outputs the comparison result signal CMP1 at high level or low level in a case where “V1a=V3a” is established.

The non-inverting input terminal and the inverting input terminal of the comparator 162 respectively receive the voltage V3b and the voltage V1b. The comparator 162 compares the voltages V3b and V1b and outputs a comparison result signal CMP2 from the output terminal thereof indicating the high-low relationship between the voltages V3b and V1b. The comparator 162 outputs the comparison result signal CMP2 at high level in a case where “V3b>V1b” is established, outputs the comparison result signal CMP2 at low level in a case where “V3b<V1b” is established, and outputs the comparison result signal CMP2 at high level or low level in a case where “V3b=V1b” is established.

The non-inverting input terminal and the inverting input terminal of the comparator 163 respectively receive the voltage V2a and the voltage V3c. The comparator 163 compares the voltages V2a and V3c and outputs a comparison result signal CMP3 from the output terminal thereof indicating the high-low relationship between the voltages V2a and V3c. The comparator 163 outputs the comparison result signal CMP3 at high level in a case where “V2a>V3c” is established, outputs the comparison result signal CMP3 at low level in a case where “V2a<V3c” is established, and outputs the comparison result signal CMP3 at high level or low level in a case where “V2a=V3c” is established.

The non-inverting input terminal and the inverting input terminal of the comparator 164 respectively receive the voltage V3d and the voltage V2b. The comparator 164 compares the voltages V3d and V2b and outputs a comparison result signal CMP4 from the output terminal thereof indicating the high-low relationship between the voltages V3d and V2b. The comparator 164 outputs the comparison result signal CMP4 at high level in a case where “V3d>V2b” is established, outputs the comparison result signal CMP4 at low level in a case where “V3d<V2b” is established, and outputs the comparison result signal CMP4 at high level or low level in a case where “V3d=V2b” is established.

The state detection circuit 16 individually detects whether there is an abnormality in the voltage generation circuits 11 to 13 based on the comparison result signals CMP1 to CMP4.In other words, the state detection circuit 16 detects abnormalities of the voltage generation circuits 11 to 13 distinctively based on the comparison result signals CMP1 to CMP4 (detects whether each of the voltage generation circuits 11 to 13 is normal or abnormal). To describe in detail, the state detection circuit 16, based on the comparison result signals CMP1 to CMP4, detects whether there is an abnormality in the voltage generation circuit 11 (detects whether the voltage generation circuit 11 is in a normal or abnormal state), detects whether there is an abnormality in the voltage generation circuit 12 (detects whether the voltage generation circuit 12 is in a normal or abnormal state), and detects whether there is an abnormality in the voltage generation circuit 13 (detects whether the voltage generation circuit 13 is in a normal or abnormal state). However, in the state detection circuit 16, the operation of detecting whether there is an abnormality in the voltage generation circuit 13 may be omitted.

Since abnormalities of the voltage generation circuits 11 to 13 can be detected distinctively, the state detection circuit 16 or the control circuit 14 can perform necessary first processing corresponding to the occurrence of abnormality of the voltage generation circuit 11 in a case of detecting an abnormality of the voltage generation circuit 11, can perform necessary second processing corresponding to the occurrence of abnormality of the voltage generation circuit 12 in a case of detecting an abnormality of the voltage generation circuit 12, and can perform necessary third processing corresponding to the occurrence of abnormality of the voltage generation circuit 13 in a case of detecting an abnormality of the voltage generation circuit 13.

An abnormality of the voltage generation circuit 11 refers to a state where the error between the actual voltage value in the first evaluation target voltage and the design voltage value (ideal voltage value) in the first evaluation target voltage exceeds a predetermined abnormality threshold TH1. The first evaluation target voltage is the reference voltage Vref. However, it may be understood that the voltage V1a or V1b is the first evaluation target voltage, or it may be understood that the output voltage of the DC voltage source 11a is the first evaluation target voltage. Since multiple voltages (the output voltage of the DC voltage source 11a, the reference voltage Vref, the voltage V1a, and the voltage V1b) generated by the voltage generation circuit 11 are in a proportional relationship with each other, in a case where the voltage value of any of these multiple generated voltages deviates from the design voltage value, the voltage values of other generated voltages also deviate in the same direction from the design voltage values. In the state detection circuit 16, the state of the voltage generation circuit 11 is detected in a binary manner. Therefore, in the state detection circuit 16, in a case where the voltage generation circuit 11 is not detected as abnormal, the voltage generation circuit 11 is detected as normal.

An abnormality of the voltage generation circuit 12 refers to a state where the error between the actual voltage value in the second evaluation target voltage and the design voltage value (ideal voltage value) in the second evaluation target voltage exceeds a predetermined abnormality threshold TH2. The second evaluation target voltage is the voltage V_H or V_L. However, it may be understood that the voltage V2a or V2b is the second evaluation target voltage, or it may be understood that the output voltage of the DC voltage source 12a is the second evaluation target voltage. Since multiple voltages (the output voltage of the DC voltage source 12a, and the voltages V_H, V_L, V2a, and V2b) generated by the voltage generation circuit 12 are in a proportional relationship with each other, in a case where the voltage value of any of these multiple generated voltages deviates from the design voltage value, the voltage values of other generated voltages also deviate in the same direction from the design voltage values. In the state detection circuit 16, the state of the voltage generation circuit 12 is detected in a binary manner. Therefore, in the state detection circuit 16, in a case where the voltage generation circuit 12 is not detected as abnormal, the voltage generation circuit 12 is detected as normal.

An abnormality of the voltage generation circuit 13 refers to a state where the error between the actual voltage value in the third evaluation target voltage and the design voltage value (ideal voltage value) in the third evaluation target voltage exceeds a predetermined abnormality threshold TH3. The third evaluation target voltage is the voltage V3a, V3b, V3c, or V3d. However, it may be understood that the output voltage of the DC voltage source 13a is the third evaluation target voltage. Since multiple voltages (the output voltage of the DC voltage source 13a, and the voltages V3a, V3b, V3c, and V3d) generated by the voltage generation circuit 13 are in a proportional relationship with each other, in a case where the voltage value of any of these multiple generated voltages deviates from the design voltage value, the voltage values of other generated voltages also deviate in the same direction from the design voltage values. In the state detection circuit 16, the state of the voltage generation circuit 13 is detected in a binary manner. Therefore, in the state detection circuit 16, in a case where the voltage generation circuit 13 is not detected as abnormal, the voltage generation circuit 13 is detected as normal.

Based on the comparison result signals CMP1 to CMP4, the state detection circuit 16 detects distinctively an all normal state where the voltage generation circuits 11, 12, and 13 are all normal, a first abnormal state where the voltage generation circuit 11 is abnormal and the voltage generation circuits 12 and 13 are normal, a second abnormal state where the voltage generation circuit 12 is abnormal and the voltage generation circuits 11 and 13 are normal, and a third abnormal state where the voltage generation circuit 13 is abnormal and the voltage generation circuits 11 and 12 are normal. It should be noted that a situation where two or more voltage generation circuits among the voltage generation circuits 11, 12, and 13 become abnormal simultaneously is unlikely to occur. Therefore, in this embodiment, it is assumed that a situation where two or more voltage generation circuits among the voltage generation circuits 11, 12, and 13 become abnormal simultaneously does not occur, and in a case where one of the voltage generation circuits 11, 12, and 13 is abnormal, it is considered that the voltages generated by the other two voltage generation circuits have the design voltage values.

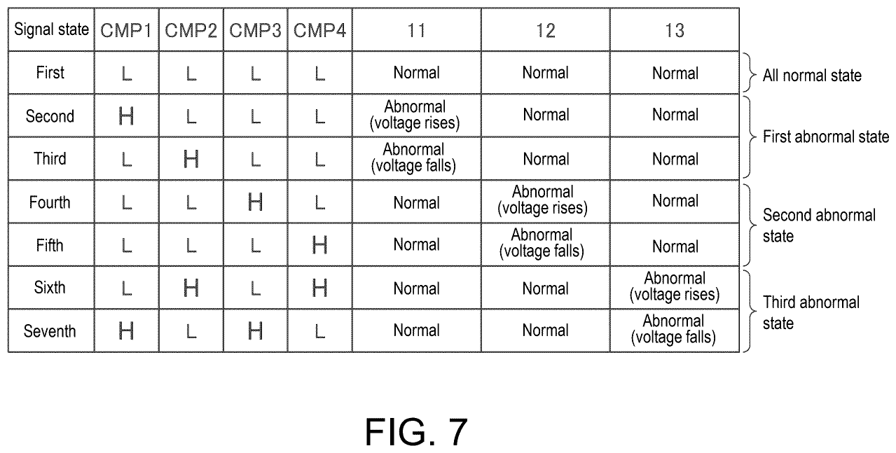

As shown in FIG. 7, the state of the signal group composed of the comparison result signals CMP1 to CMP4 becomes one of the first to seventh signal states. In the first signal state, the comparison result signals CMP1 to CMP4 all have low level. In the second signal state, the comparison result signal CMP1 has high level and the comparison result signals CMP2 to CMP4 have low level. In the third signal state, the comparison result signal CMP2 has high level and the comparison result signals CMP1, CMP3, and CMP4 have low level. In the fourth signal state, the comparison result signal CMP3 has high level and the comparison result signals CMP1, CMP2, and CMP4 have low level. In the fifth signal state, the comparison result signal CMP4 has high level and the comparison result signals CMP1 to CMP3 have low level. In the sixth signal state, the comparison result signals CMP2 and CMP4 have high level and the comparison result signals CMP1 and CMP3 have low level. In the seventh signal state, the comparison result signals CMP1 and CMP3 have high level and the comparison result signals CMP2 and CMP4 have low level. In a case where the comparison result signals CMP1 to CMP4 are in the first signal

state, the state detection circuit 16 detects and judges that the voltage generation circuits 11, 12, and 13 are in the all normal state.

In a case where the comparison result signals CMP1 to CMP4 are in the second signal state or the third signal state, the state detection circuit 16 detects and judges that the voltage generation circuits 11, 12, and 13 are in the first abnormal state (detects that there is an abnormality in the voltage generation circuit 11; refer to FIG. 7). The abnormality of the voltage generation circuit 11 in the second signal state is an abnormality where the voltage value of each generated voltage of the voltage generation circuit 11 becomes excessive from the viewpoint of the design voltage value, and the abnormality of the voltage generation circuit 11 in the third signal state is an abnormality where the voltage value of each generated voltage of the voltage generation circuit 11 becomes insufficient from the viewpoint of the design voltage value.

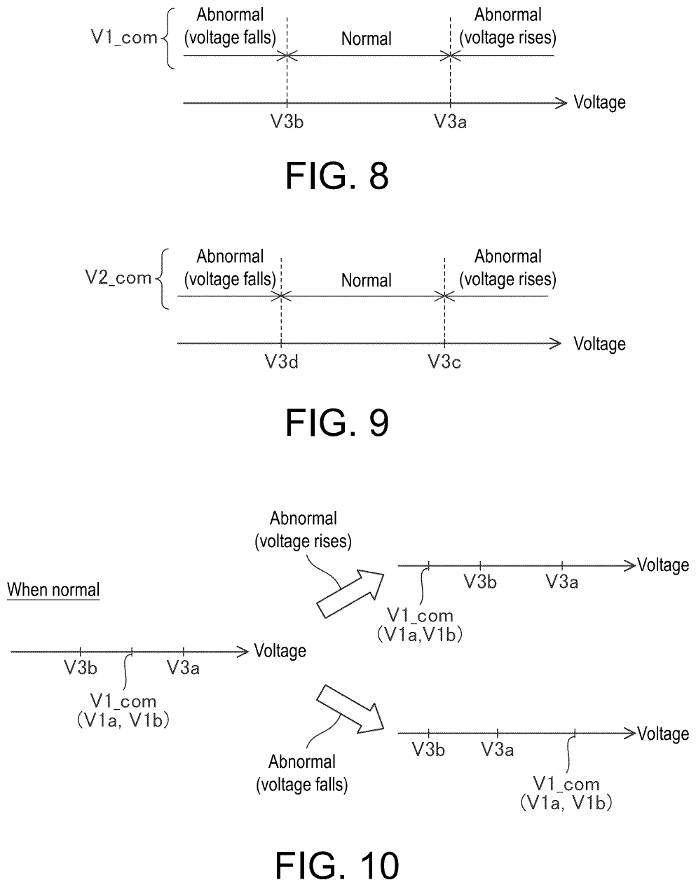

Under the premise that the voltage generation circuit 13 is normal (under the premise that each generated voltage of the voltage generation circuit 13 has the design voltage value), the comparators 161 and 162 form a window comparator that determines whether the generated voltage of the voltage generation circuit 11 is excessive or insufficient. Specifically, the following may be performed, for example. That is, after setting the voltages V1a and V1b to a common voltage V1_com, the voltages V3a and V3b satisfying “V3a>V3b” are generated by the voltage generation circuit 13 (refer to FIG. 8). Then, the comparators 161 and 162 determine whether the voltage V1_com falls within the voltage range from the voltage V3b to the voltage V3a. In a case where each generated voltage of the voltage generation circuits 11 and 13 has the design voltage value, it is assumed that “V3b<V1a=V1b=V1_com<V3a” is established. Then, under the premise that the voltage generation circuit 13 is normal, in a case where the voltage generation circuit 11 is normal, “V3b<V1a=V1b=V1_com<V3a” is established, so the comparison result signals CMP1 and CMP2 both become low level.

In a case where “V3b<V3a<V1a=V1b=V1_com” is established because an abnormality occurs in the voltage generation circuit 11 where each generated voltage of the voltage generation circuit 11 rises from the design voltage value, the comparison result signals CMP1 and CMP2become high level and low level, respectively. Conversely, in a case where “V1a=V1b=V1_com<V3b<V3a” is established because an abnormality occurs in the voltage generation circuit 11 where each generated voltage of the voltage generation circuit 11 falls from the design voltage value, the comparison result signals CMP1 and CMP2 become low level and high level, respectively.

In a case where the comparison result signals CMP1 to CMP4 are in the fourth signal state or the fifth signal state, the state detection circuit 16 detects and judges that the voltage generation circuits 11, 12, and 13 are in the second abnormal state (detects that there is an abnormality in the voltage generation circuit 12; refer to FIG. 7). The abnormality of the voltage generation circuit 12 in the fourth signal state is an abnormality where the voltage value of each generated voltage of the voltage generation circuit 12 becomes excessive from the viewpoint of the design voltage value, and the abnormality of the voltage generation circuit 12 in the fifth signal state is an abnormality where the voltage value of each generated voltage of the voltage generation circuit 12 becomes insufficient from the viewpoint of the design voltage value.

Under the premise that the voltage generation circuit 13 is normal (under the premise that each generated voltage of the voltage generation circuit 13 has the design voltage value), the comparators 163 and 164 form a window comparator that determines whether the generated voltage of the voltage generation circuit 12 is excessive or insufficient. Specifically, the following may be performed, for example. That is, after setting the voltages V2a and V2b to a common voltage V2_com, the voltages V3c and V3d satisfying “V3c>V3d” are generated by the voltage generation circuit 13 (refer to FIG. 9). Then, the comparators 163 and 164 determine whether the voltage V2_com falls within the voltage range from the voltage V3d to the voltage V3c. In a case where each generated voltage of the voltage generation circuits 12 and 13 has the design voltage value, it is assumed that “V3d<V2a=V2b=V2_com<V3c” is established. Then, under the premise that the voltage generation circuit 13 is normal, in a case where the voltage generation circuit 12 is normal, “V3d<V2a=V2b=V2_com<V3c” is established, so the comparison result signals CMP3 and CMP4 both become low level.

In a case where “V3d<V3c<V2a=V2b=V2_com” is established because an abnormality occurs in the voltage generation circuit 12 where each generated voltage of the voltage generation circuit 12 rises from the design voltage value, the comparison result signals CMP3 and CMP4 become high level and low level, respectively. Conversely, in a case where “V2a=V2b=V2_com<V3d<V3c” is established because an abnormality occurs in the voltage generation circuit 12 where each generated voltage of the voltage generation circuit 12 falls from the design voltage value, the comparison result signals CMP3 and CMP4 become low level and high level, respectively.

In a case where the comparison result signals CMP1 to CMP4 are in the sixth signal state or the seventh signal state, the state detection circuit 16 detects and judges that the voltage generation circuits 11, 12, and 13 are in the third abnormal state (detects that there is an abnormality in the voltage generation circuit 13; refer to FIG. 7). The abnormality of the voltage generation circuit 13 in the sixth signal state is an abnormality where the voltage value of each generated voltage of the voltage generation circuit 13 becomes excessive from the viewpoint of the design voltage value, and the abnormality of the voltage generation circuit 13 in the seventh signal state is an abnormality where the voltage value of each generated voltage of the voltage generation circuit 13 becomes insufficient from the viewpoint of the design voltage value.

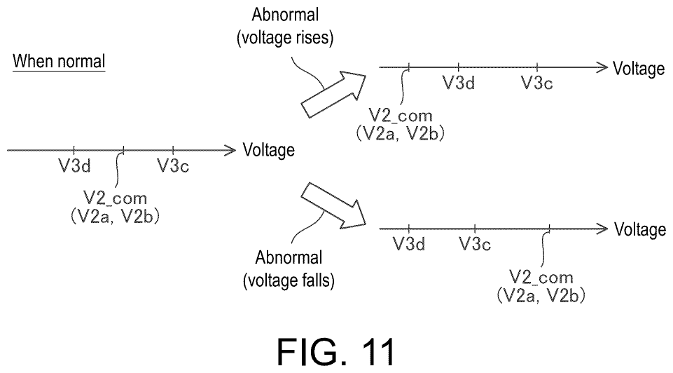

Under the premise that the voltage generation circuits 11 and 12 are normal (under the premise that each generated voltage of the voltage generation circuits 11 and 12 has the design voltage value), the comparators 161 to 164 form a window comparator that determines whether the generated voltage of the voltage generation circuit 13 is excessive or insufficient. Specifically, the following may be performed, for example. That is, after setting the voltages V1a and V1b the common voltage V1_com and the voltages V2a and V2b to the common voltage V2_com, the voltages V3a to V3d satisfying “V3a>V3b” and “V3c>V3d” are generated by the voltage generation circuit 13 (refer to FIG. 10 and FIG. 11). In a case where each generated voltage of the voltage generation circuits 11 to 13 has the design voltage value, it is assumed that “V3b<V1a=V1b=V1_com<V3a” and “V3d<V2a=V2b=V2_com<V3c” are established (refer to FIG. 10 and FIG. 11). Then, under the premise that the voltage generation circuit 11 is normal, in a case where the voltage generation circuit 13 is normal,

“V3b<V1a=V1b=V1_com<V3a” is established, so the comparison result signals CMP1 and CMP2 both become low level. Under the premise that the voltage generation circuit 12 is normal, in a case where the voltage generation circuit 13 is normal, “V3d<V2a=V2b=V2_com<V3c” is established, so the comparison result signals CMP3 and CMP4 both become low level.

In a case where an abnormality occurs in the voltage generation circuit 13 where each generated voltage of the voltage generation circuit 13 rises from the design voltage value, “V1a=V1b=V1_com<V3b<V3a” and “V2a=V2b=V2_com<V3d<V3c” are established (refer to FIG. 10 and FIG. 11), and as a result, the comparison result signals CMP2 and CMP4 become high level while the comparison result signals CMP1 and CMP3 become low level. Conversely, in a case where an abnormality occurs in the voltage generation circuit 13 where each generated voltage of the voltage generation circuit 13 falls from the design voltage value, “V3b<V3a<V1a=V1b=V1_com” and “V3d<V3c<V2a=V2b=V2_com” are established (refer to FIG. 10 and FIG. 11), and as a result, the comparison result signals CMP2 and CMP4 become low level while the comparison result signals CMP1 and CMP3 become high level.

The examples of relationships between the voltages V1a, V1b, V2a, V2b, V3a, V3b, V3c, and V3d for detecting whether the voltage generation circuits 11 to 13 are normal or abnormal have been described above with reference to FIG. 8 to FIG. 11, but the relationships between those voltages may be set in various ways as long as the normality or abnormality of each of the voltage generation circuits 11 to 13 can be detected. For example, even if the design voltage value of the voltage V1a is made smaller than the design voltage value of the voltage V1b after setting the design voltage values of the voltages V3a and V3b to be the same, it is possible to correctly detect the normality or abnormality of the voltage generation circuit 11 from the comparison result signals CMP1 and CMP2. The same applies to the detection for normality or abnormality related to the voltage generation circuits 12 and 13.

Thus, according to the state detection circuit 16, it is possible to distinctively detect which of the voltage generation circuits 11 to 13 has an abnormality.

In a case where the state detection circuit 16 detects that there is an abnormality in any of the voltage generation circuits 11 to 13, abnormality detection flag data indicating that the abnormality has been detected may be saved in a memory within the power supply control device 2A. The memory in which the abnormality detection flag data is saved may be a non-volatile memory or a volatile memory. The abnormality detection flag data may include information indicating which of the voltage generation circuits 11 to 13 is the voltage generation circuit detected to have an abnormality. The state detection circuit 16 may transmit the above-mentioned abnormality detection flag data to the MPU 4 in a case of detecting that there is an abnormality in any of the voltage generation circuits 11 to 13. The transmission of the abnormality detection flag data may be performed using an interface based on SPI (Serial Peripheral Interface) or I²C (Inter-Integrated Circuit) or Microwire.

### Second Implementation Example

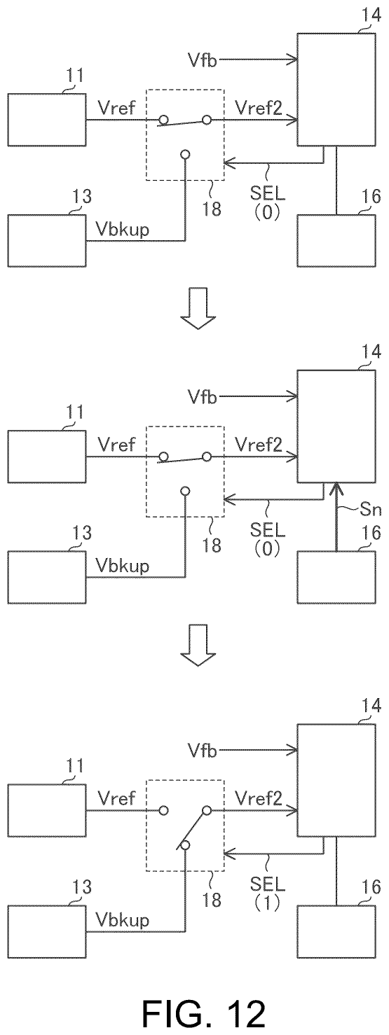

The second implementation example will be described. The second implementation example is implemented in combination with the first implementation example. In response to obtaining the comparison result signals CMP1 to CMP4 in the second signal state or the third signal state (refer to FIG. 7), the control circuit 14 according to the second implementation example can perform switching control of the output stage circuit MM using a backup voltage Vbkup generated by the voltage generation circuit 13 instead of the reference voltage Vref. FIG. 12 shows an overview of the operation according to the second implementation example.

The voltage generation circuit 13 according to the second implementation example generates the backup voltage Vbkup as a voltage proportional to the output voltage of the DC voltage source 13a (refer to FIG. 3). Therefore, in a case where the output voltage of the reference voltage source 13a is the voltage V13a, “Vbkup=k3e×V13a” is established. k3e is a predetermined positive proportionality constant, and may have a value of 1. Any of the above-mentioned voltages V3a to V3d may be the backup voltage Vbkup.

The design voltage value of the backup voltage Vbkup is the same as the design voltage value of the reference voltage Vref. That is, the voltage generation circuit 13 generates the backup voltage Vbkup so that the backup voltage Vbkup has the same voltage value as the design voltage value of the reference voltage Vref. For example, in a case where the design voltage value (ideal voltage value) of the reference voltage Vref is 0.80V, the voltage generation circuit 13 generates the backup voltage Vbkup so that the backup voltage Vbkup becomes 0.80V.

A selector 18 is added to the power supply control device 2A according to the second implementation example. The selector 18 selects either the reference voltage Vref generated by the voltage generation circuit 11 or the backup voltage Vbkup generated by the voltage generation circuit 13, and supplies the selected voltage to the control circuit 14 as an adopted reference voltage Vref2. The control circuit 14 supplies a selection signal SEL to the selector 18. The selection signal SEL is a binary signal having a value of “0” or “1.” In a case where the selection signal SEL has a value of “0,” the reference voltage Vref is selected by the selector 18, and therefore, the adopted reference voltage Vref2 matches the reference voltage Vref. In a case where the selection signal SEL has a value of “1,” the backup voltage Vbkup is selected by the selector 18, and therefore, the adopted reference voltage Vref2 matches the backup voltage Vbkup.

The control circuit 14 in principle supplies the selector 18 with the selection signal SEL having a value of “,” and maintains the value of the selection signal SEL at “0” unless the comparison result signals CMP1 to CMP4 in the second signal state or the third signal state are obtained. Subsequently, in a case where the comparison result signals CMP1 to CMP4 in the second signal state or the third signal state are obtained (that is, in a case where an abnormality of the voltage generation circuit 11 is detected), a specific abnormality notification signal Sn is output from the state detection circuit 16 to the control circuit 14. The specific abnormality notification signal Sn indicates that the voltage generation circuits 11 to 13 are in the first abnormal state (that is, indicating that an abnormality of the voltage generation circuit 11 is detected). In a case of receiving the specific abnormality notification signal Sn, the control circuit 14 changes the value of the selection signal SEL from “0” to “1.” Thus, the adopted reference voltage Vref2 is switched from the reference voltage Vref to the backup voltage Vbkup. Thereafter, unless a predetermined release condition is established, the adopted reference voltage Vref2 may be maintained at the backup voltage Vbkup.

The control circuit 14 according to the second implementation example performs switching control of the output stage circuit MM based on the feedback voltage Vfb and the adopted reference voltage Vref2. That is, in the switching control of the output stage circuit MM, the control circuit 14 according to the second implementation example controls the on/off state of each of the transistors MH and ML through level control of the gate signals GH and GL so that the error between the feedback voltage Vfb and the adopted reference voltage Vref2 approaches zero (ideally coincides with zero), thereby stabilizing the output voltage Vout at a predetermined target voltage Vtg. In a case where the error between the feedback voltage Vfb and the adopted reference voltage Vref2 is zero, the output voltage Vout matches the target voltage Vtg (but assuming that the voltage value of the adopted reference voltage Vref2 matches the design voltage value of the reference voltage Vref).

According to the second implementation example, it is possible to properly maintain the operation of the power supply device 1A (the operation of stabilizing the output voltage Vout at the desired target voltage Vtg) using the voltage generated by the voltage generation circuit 13 provided for abnormality detection of the voltage generation circuits 11 and 12 even in a case where an abnormality occurs in the voltage generation circuit 11.

In a case of receiving the specific abnormality notification signal Sn while executing switching control of the output stage circuit MM, the control circuit 14 may immediately switch the value of the selection signal SEL from “0” to “1” while continuing the switching control of the output stage circuit MM. Alternatively, in a case of receiving the specific abnormality notification signal Sn while executing switching control of the output stage circuit MM, the control circuit 14 may hold selector flag data corresponding to the reception of the specific abnormality notification signal Sn in the non-volatile memory thereof without immediately switching the value of the selection signal SEL from “0” to “1.” In this case, when the power supply control device 2A restarts after an operation stop of the power supply control device 2A (including stop of the switching control) based on the interruption of the input voltage Vin, etc., the control circuit 14 may set the value of the selection signal SEL to “1” based on the selector flag data held in the non-volatile memory, and then start the switching control of the output stage circuit MM.

### Third Implementation Example

The third implementation example will be described. The control system for stabilizing the output voltage Vout at the target voltage Vtg is arbitrary. For example, a pulse width modulation system may be adopted in this control system. In a case where the pulse width modulation system is adopted, the on duty of the output stage circuit MM is controlled while keeping the switching frequency of the output stage circuit MM (the switching frequency of the transistor MH) constant. At this time, the control circuit 14 performs feedback control to increase the on duty of the output stage circuit MM in a case of “Vfb<Vref2,” and decrease the on duty of the output stage circuit MM in a case of “Vfb>Vref2.” The voltage Vref2 here is the adopted reference voltage Vref2mentioned in the second implementation example. In a case of not using the technology shown in the second implementation example, the adopted reference voltage Vref2 always matches the reference voltage Vref. The on duty of the output stage circuit MM is a ratio of the on period of the transistor MH to the sum of the on period of the transistor MH and the off period of the transistor MH.

In addition, in the control system for stabilizing the output voltage Vout at the target voltage Vtg, a pulse frequency modulation system may be adopted, or a constant on-time control system may be adopted.

### Fourth Implementation Example

The fourth implementation example will be described.

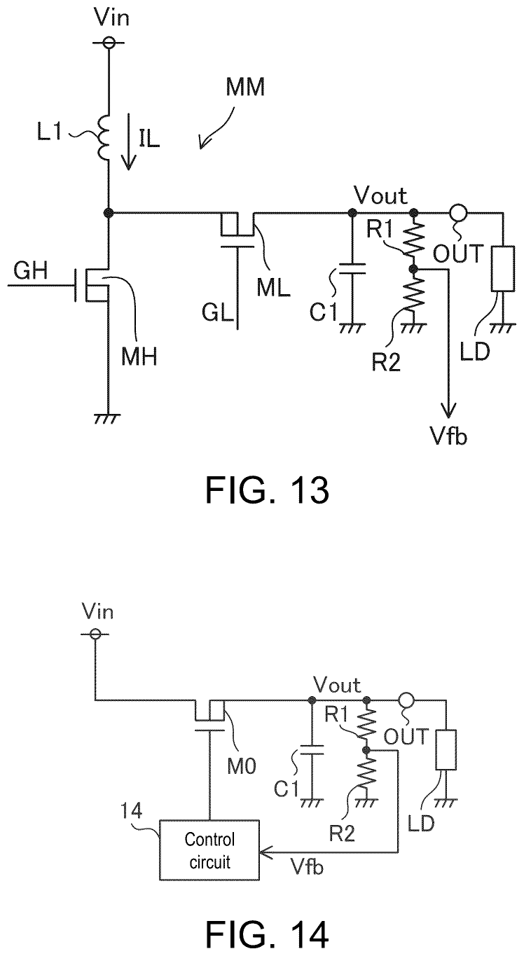

While the power supply device 1A shown in FIG. 3 as an example of the power supply device 1 is a step-down type switching power supply device (switching regulator), the power supply device 1 may also be a step-up type switching power supply device. The step-up type switching power supply device generates an output voltage Vout higher than the input voltage Vin by boosting the input voltage Vin. FIG. 13 is a partial configuration diagram of the power supply device 1 in a case where the power supply device 1 is a step-up type switching power supply device. In a case where the power supply device 1 is a step-up type switching power supply device, as shown in FIG. 13, the first terminal of the coil L1 is connected to the application terminal of the input voltage Vin (terminal to which the input voltage Vin is applied), the second terminal of the coil LI is connected to the drain of the transistor MH and the source of the transistor ML, the source of the transistor MH is connected to the ground, and the drain of the transistor ML is connected to the output terminal OUT and also connected to the ground through the capacitor C1. The transistors MH and ML are alternately turned on and off by the control circuit 14 so that the error between the feedback voltage Vfb and the adopted reference voltage Vref2 approaches zero. It should be noted that in a case where the technology shown in the second implementation example is not used, the adopted reference voltage Vref2 always matches the reference voltage Vref. In the configuration of FIG. 13, the transistor ML serving as a rectification element may be replaced with a synchronous rectification diode having an anode connected to the drain of the transistor MH and a cathode connected to the output terminal OUT. In any case, the output voltage Vout is generated based on the current (IL) flowing through the coil L1 by switching the output element (MH) between on and off in the switching drive of the output stage MM. The power supply device 1 may also be a step-up/step-down type switching power supply device.

The power supply device 1 may also be a linear regulator (series regulator). FIG. 14 is a partial configuration diagram of the power supply device 1 in a case where the power supply device 1 is a linear regulator. In a case where the power supply device 1 is a linear regulator, as shown in FIG. 14, the output stage circuit MM is constituted by only an output transistor M0. The output transistor M0 in FIG. 14 is an N-channel type MOSFET, but a P-channel type MOSFET may be used as the output transistor M0, or a bipolar transistor may be used as the output transistor M0. In FIG. 14, the drain of the output transistor M0 is connected to the application terminal of the input voltage Vin, and the source of the output transistor M0 is connected to the output terminal OUT (without the coil L1 being provided as described above, the source of the output transistor M0 is directly connected to the output terminal OUT). The point that the output capacitor C1 and the series circuit of the feedback resistors R1 and R2 are provided between the output terminal OUT and the ground is as described above. In a case where the power supply device 1 is a linear regulator, the control circuit 14 controls the gate voltage of the output transistor M0 so that the error between the feedback voltage Vfb and the adopted reference voltage Vref2 approaches zero. It should be noted that in a case where the technology shown in the second implementation example is not used, the adopted reference voltage Vref2 always matches the reference voltage Vref.

In addition, the technology according to the disclosure can be widely applied to a power supply device that generates an output voltage Vout from an input voltage Vin by power conversion, and stabilizes the output voltage Vout by feedback control based on a feedback voltage Vfb corresponding to the output voltage Vout and an adopted reference voltage Vref2 (Vref or Vbkup).

The system of FIG. 1 can be mounted in any electrical equipment. The electrical equipment may be an electrical device mounted in a vehicle such as an automobile, a computer device, or a home appliance or industrial equipment.

For any signal or voltage, the relationship between high level and low level may be reversed from what has been described above without compromising the above-mentioned purpose.

The types of channels of the FETs (field effect transistors) shown in the above embodiments are exemplary. The channel type of any FET may be changed between P-channel type and N-channel type without compromising the above-mentioned purpose.

Any transistor mentioned above may be of any type as long as no inconvenience occurs. For example, any transistor described above as a MOSFET may be replaced, as long as no inconvenience occurs, with a junction type FET, an IGBT (Insulated Gate Bipolar Transistor), or a bipolar transistor. Any transistor includes a first electrode, a second electrode, and a control electrode. In a FET, one of the first and second electrodes is a drain and the other is a source, and the control electrode is a gate. In an IGBT, one of the first and second electrodes is a collector and the other is an emitter, and the control electrode is a gate. In a bipolar transistor that does not belong to an IGBT, one of the first and second electrodes is a collector and the other is an emitter, and the control electrode is a base.

In the disclosure, when any first physical quantity and any second physical quantity are “the same,” it should be interpreted as a concept that includes an error. That is, when the first physical quantity and the second physical quantity are “the same,” it means that the design or manufacturing has been performed with the aim to make the first physical quantity and the second physical quantity “the same,” and even if there is a slight error between the first and second physical quantities, it should be interpreted that the first physical quantity and the second physical quantity are “the same.” This applies not only to physical quantities but also to expressions similar to “the same” (such as “identical” or “matching”), which should be interpreted in the same way.

Embodiments of the disclosure may be appropriately modified in various ways within the scope of the technical concept shown in the scope of the claims. The above embodiments are merely examples of embodiments of the disclosure, and the meanings of the terms of the disclosure or the components are not limited to those described in the above embodiments. The specific numerical values shown in the above description are merely examples, and, as a matter of course, these can be changed to various numerical values.

### Appendix

An appendix is provided for the disclosure, for which specific configuration examples have been shown in the above embodiments.

A power supply control device according to one aspect of the disclosure is a power supply control device (2, 2A) including an output stage circuit (MM) provided between an input terminal (IN) to which an input voltage (Vin) is applied and an output terminal (OUT) to which an output voltage (Vout) is applied, and constituting a power supply device (1, 1A) configured to generate the output voltage from the input voltage, the power supply control device having a configuration including: a first voltage generation circuit (11); a control circuit (14) configured to stabilize the output voltage at a target voltage by controlling a state of the output stage circuit based on a feedback voltage (Vfb) corresponding to the output voltage and a reference voltage (Vref) generated by the first voltage generation circuit; a second voltage generation circuit (12); an output abnormality monitoring circuit (15) configured to monitor an abnormality of the output voltage based on the feedback voltage and an output monitoring voltage (V_H, V_L) generated by the second voltage generation circuit; a third voltage generation circuit (13); and a state detection circuit (16) configured to detect abnormalities of the first voltage generation circuit and the second voltage generation circuit distinctively based on a first determination voltage (V1a, V1b) generated by the first voltage generation circuit, a second determination voltage (V2a, V2b) generated by the second voltage generation circuit, and a third determination voltage (V3a, V3b, V3c, V3d) generated by the third voltage generation circuit (first configuration).

This makes it possible to properly detect distinctively between whether an abnormality has occurred in the first voltage generation circuit or in the second voltage generation circuit. Therefore, it is beneficial as it becomes possible to perform necessary first processing corresponding to an abnormality of the first voltage generation circuit in a case where an abnormality of the first voltage generation circuit is detected, or to perform necessary second processing corresponding to an abnormality of the second voltage generation circuit in a case where an abnormality of the second voltage generation circuit is detected.

In the power supply control device according to the first configuration, the state detection circuit may detect abnormalities of the first voltage generation circuit, the second voltage generation circuit, and the third voltage generation circuit distinctively based on the first determination voltage, the second determination voltage, and the third determination voltage (second configuration).

It is beneficial as this makes it possible to perform necessary first processing corresponding to an abnormality of the first voltage generation circuit in a case where an abnormality of the first voltage generation circuit is detected, to perform necessary second processing corresponding to an abnormality of the second voltage generation circuit in a case where an abnormality of the second voltage generation circuit is detected, and to perform necessary third processing corresponding to an abnormality of the third voltage generation circuit in a case where an abnormality of the third voltage generation circuit is detected.

In the power supply control device according to the second configuration, in a case where an abnormality of the first voltage generation circuit is detected, the control circuit may use a backup voltage (Vbkup) generated by the third voltage generation circuit instead of the reference voltage, and control the state of the output stage circuit based on the feedback voltage and the backup voltage (third configuration).

This makes it possible to properly maintain the operation of the power supply device (the operation of stabilizing the output voltage at the target voltage) using the voltage generated by the third voltage generation circuit provided for abnormality detection of the first and second voltage generation circuits even in a case where an abnormality occurs in the first voltage generation circuit.

In the power supply control device according to the third configuration, the third voltage generation circuit may generate the backup voltage so that the backup voltage has a same voltage value as a design voltage value of the reference voltage (fourth configuration).

This makes it possible to properly maintain the operation of the power supply device (the operation of stabilizing the output voltage at the target voltage) even in a case where an abnormality occurs in the first voltage generation circuit.

In the power supply control device according to any one of the first to fourth configurations, the first determination voltage may be proportional to the reference voltage, and the second determination voltage may be proportional to the output monitoring voltage (fifth configuration).

In the power supply control device according to any one of the first to fourth configurations, the state detection circuit may include a first comparator (CMP1) configured to compare a first voltage (V1a) and a second voltage (V3a), a second comparator (CMP2) configured to compare a third voltage (V3b) and a fourth voltage (V1b), a third comparator (CMP3) configured to compare a fifth voltage (V2a) and a sixth voltage (V3c), and a fourth comparator (CMP4) configured to compare a seventh voltage (V3d) and an eighth voltage (V2b), and detect abnormalities of the first voltage generation circuit, the second voltage generation circuit, and the third voltage generation circuit distinctively based on comparison results of the first comparator to the fourth comparator, the first determination voltage includes the first voltage and the fourth voltage, and the first voltage, the fourth voltage, and the reference voltage are in a proportional relationship with each other, the second determination voltage includes the fifth voltage and the eighth voltage, and the fifth voltage, the eighth voltage, and the output monitoring voltage are in a proportional relationship with each other, and the third determination voltage includes the second voltage, the third voltage, the sixth voltage, and the seventh voltage, and the second voltage, the third voltage, the sixth voltage, and the seventh voltage are in a proportional relationship with each other (sixth configuration).

In the power supply control device according to the sixth configuration, the state detection circuit may detect, based on the comparison results of the first comparator to the fourth comparator, a state where the first voltage generation circuit to the third voltage generation circuit are all normal, a state where the first voltage generation circuit is abnormal and the second voltage generation circuit and the third voltage generation circuit are normal, a state where the second voltage generation circuit is abnormal and the first voltage generation circuit and the third voltage generation circuit are normal, and a state where the third voltage generation circuit is abnormal and the first voltage generation circuit and the second voltage generation circuit are normal, distinctively (seventh configuration).

In the power supply control device according to any one of the first to seventh configurations, the output monitoring voltage may include a first output monitoring voltage (V_L) and a second output monitoring voltage (V_H) higher than the first output monitoring voltage, and the output abnormality monitoring circuit may monitor an abnormality of the output voltage by monitoring whether the feedback voltage falls within a voltage range from the first output monitoring voltage to the second output monitoring voltage (eighth configuration).

In the power supply control device according to any one of the first to eighth configurations, the output stage circuit may be provided in the power supply control device (ninth configuration).

In the power supply control device according to any one of the first to eighth configurations, the output stage circuit provided outside the power supply control device may be connected to the power supply control device (tenth configuration).

What is claimed is:

1. A power supply control device, comprising an output stage circuit provided between an input terminal to which an input voltage is applied and an output terminal to which an output voltage is applied, and constituting a power supply device configured to generate the output voltage from the input voltage, the power supply control device comprising:
a first voltage generation circuit;
a control circuit configured to stabilize the output voltage at a target voltage by controlling a state of the output stage circuit based on a feedback voltage corresponding to the output voltage and a reference voltage generated by the first voltage generation circuit;
a second voltage generation circuit;
an output abnormality monitoring circuit configured to monitor an abnormality of the output voltage based on the feedback voltage and an output monitoring voltage generated by the second voltage generation circuit;
a third voltage generation circuit; and
a state detection circuit configured to detect abnormalities of the first voltage generation circuit and the second voltage generation circuit distinctively based on a first determination voltage generated by the first voltage generation circuit, a second determination voltage generated by the second voltage generation circuit, and a third determination voltage generated by the third voltage generation circuit.

2. The power supply control device according to claim 1, wherein
the state detection circuit detects abnormalities of the first voltage generation circuit, the second voltage generation circuit, and the third voltage generation circuit distinctively based on the first determination voltage, the second determination voltage, and the third determination voltage.

3. The power supply control device according to claim 2, wherein
in a case where an abnormality of the first voltage generation circuit is detected, the control circuit uses a backup voltage generated by the third voltage generation circuit instead of the reference voltage, and controls the state of the output stage circuit based on the feedback voltage and the backup voltage.

4. The power supply control device according to claim 3, wherein
the third voltage generation circuit generates the backup voltage so that the backup voltage has a same voltage value as a design voltage value of the reference voltage.

5. The power supply control device according to claim 1, wherein
the first determination voltage is proportional to the reference voltage, and the second determination voltage is proportional to the output monitoring voltage.

6. The power supply control device according to claim 1, wherein
the state detection circuit comprises a first comparator configured to compare a first voltage and a second voltage, a second comparator configured to compare a third voltage and a fourth voltage, a third comparator configured to compare a fifth voltage and a sixth voltage, and a fourth comparator configured to compare a seventh voltage and an eighth voltage, and detects abnormalities of the first voltage generation circuit, the second voltage generation circuit, and the third voltage generation circuit distinctively based on comparison results of the first comparator to the fourth comparator,
the first determination voltage includes the first voltage and the fourth voltage, and the first voltage, the fourth voltage, and the reference voltage are in a proportional relationship with each other,
the second determination voltage includes the fifth voltage and the eighth voltage, and the fifth voltage, the eighth voltage, and the output monitoring voltage are in a proportional relationship with each other, and
the third determination voltage includes the second voltage, the third voltage, the sixth voltage, and the seventh voltage, and the second voltage, the third voltage, the sixth voltage, and the seventh voltage are in a proportional relationship with each other.

7. The power supply control device according to claim 6, wherein
the state detection circuit detects, based on the comparison results of the first comparator to the fourth comparator, a state where the first voltage generation circuit to the third voltage generation circuit are all normal, a state where the first voltage generation circuit is abnormal and the second voltage generation circuit and the third voltage generation circuit are normal, a state where the second voltage generation circuit is abnormal and the first voltage generation circuit and the third voltage generation circuit are normal, and a state where the third voltage generation circuit is abnormal and the first voltage generation circuit and the second voltage generation circuit are normal, distinctively.

8. The power supply control device according to claim 1, wherein
the output monitoring voltage includes a first output monitoring voltage and a second output monitoring voltage higher than the first output monitoring voltage, and
the output abnormality monitoring circuit monitors an abnormality of the output voltage by monitoring whether the feedback voltage falls within a voltage range from the first output monitoring voltage to the second output monitoring voltage.

9. The power supply control device according to claim 1, wherein
the output stage circuit is provided in the power supply control device.

10. The power supply control device according to claim 1, wherein
the output stage circuit provided outside the power supply control device is connected to the power supply control device.
